(19) United States
(12) Patent Application Publication
(10) Pub. No.: US 2002/0149720 A1
(43) Pub. Date: Oct. 17, 2002

(54) Liquid crystal display device having spacers with reduced visible artifacts

(76) Inventors: Peter J. Janssen, Scarborough, NY (US); George A. Melnik, Montrose, NY (US)

Correspondence Address: U.S. Philips Corporation, 580 White Plains Road, Tarrytown, NY, 10591, US

(21) Appl. No.: 09/835,577

(22) Filed: Apr. 17, 2001

(51) Int. Cl. G02F 1/1335

(52) U.S. Cl. 349/113

(57) ABSTRACT

A normally-white mode reflective liquid crystal display (LCD) device includes a combination of a narrow inter-pixel gap between pixel electrodes, and very narrow spacers placed in the inter-pixel gaps at a high spacer density to increase the contrast ratio of the device and to reduce visible artifacts. Preferably, each spacer is located approximately equidistant from the corners of four pixel electrodes. Also, beneficially, the ratio of the width of the pixel electrodes to the width of the inter-pixel gaps is at least approximately 10:1.

### BACKGROUND OF THE INVENTION

1) Field of the Invention

This invention pertains to the field of liquid crystal display (LCD) devices, such as liquid crystal on silicon (LCOS) devices, and more particularly to an arrangement of integrated spacers for such an LCD device.

2) Description of the Related Art

Reflective LCD devices are well known. Examples of such devices, and in particular active matrix devices, are shown in U.S. Pat. Nos. 6,023,309 and 6,052,165. With reference to the following description, familiarity with conventional features of such devices will be assumed, so that only features bearing on the present invention will be described.

FIG. 1 shows a portion of a typical prior art reflective LCD device 100, and FIG. 2 shows a top plan view of a portion of the prior art reflective LCD device 100. The reflective LCD device 100 comprises, in relevant part, a silicon substrate 110, an insulating layer 112, a liquid crystal (LC) layer 114, a transparent electrode 116, such as indium-tin-oxide (ITO), and a transparent (e.g., glass) layer 118. A reflective mirror (pixel) metal layer 120 is provided beneath the liquid crystal layer 114 on the insulating layer 112. The mirror metal layer 120 includes a plurality of individual reflective pixel electrodes 120a. Cell gap, or inter-pixel gap, regions 122 are located between the pixel electrodes 120a.

Also provided in the insulating layer 112 and between the mirror metal layer 120 and the substrate 110 are a light shield metal layer 124 and routing metal layers, 128 and 130. The metal layers 128 and 130 form mutually-orthogonal row and column lines, which may be connected to gate and source electrodes of MOS transistors (not shown in FIG. 1) for pixel elements fabricated in the underlying substrate 110. Also, metal plugs 132 are provided for connecting various portions of the light shield metal layer 124 and the third and fourth metal layers 128, 130 with each other.

In the reflective LCD device 100, a light mask is not used. However, a plurality of spacers or pillars 134 are provided for supporting the transparent electrode 116 and the transparent layer 118 and providing a gap for the liquid crystal layer 114.

As can be seen in FIG. 2, the spacers 134 are placed sporadically between pixel electrodes 120a in the reflective LCD device 100. In the prior art device 100, a typical width “P” of the pixel electrode 120a may be 10 μm, and a typical width “G” of a cell gap 122 may be 5 μm. That is, a ratio of a size of a pixel to a cell gap may be approximately 2:1.

However, in the prior art reflective LCD device 100, the spacers 134 produce undesirable visible artifacts in the display, as will be explained below.

FIGS. 3A-B illustrate an example of planar aligned LC crystal molecules in a liquid crystal cell which is located near a spacer 134. Meanwhile, FIGS. 3C-D illustrate an example of vertically aligned LC crystal molecules in a liquid crystal cell which is located near a spacer 134.

FIGS. 3A-B will hereafter be used to explain a mechanism by which the spacers 134 produce undesirable visible artifacts, particularly in a prior art “normally-black” mode LCD device. In the “normally-black” mode LCD device, when no electric field is applied to the pixel electrodes, the liquid crystal cells are turned off to display a black pixel, and when an electric field is applied to the pixel electrodes, the liquid crystal cells are turned on to display a white pixel.

FIG. 3A illustrates the orientation of the optical axes of the planar aligned LC molecules in the liquid crystal cell when no electric field is applied to the liquid crystal cell, and FIG. 3B illustrates the orientation of the optical axes of the LC molecules in the same liquid crystal cell when an electric field is applied to the cell. With no voltage applied to the planar aligned LC layer, the LC molecules tend to align themselves in parallel to exposed surfaces. Therefore, as shown in FIG. 3A, with no voltage applied to the cell the LC molecules tend to align with the top and bottom surfaces of the liquid crystal cell, i.e., in parallel with the top surface of the underlying pixel electrode 120a and the bottom surface of the overlying transparent electrode 116. In contrast, as shown in FIG. 3B, when an electric field is applied to the liquid crystal cell, the LC molecules tend to align themselves in parallel with the electric field, i.e., perpendicular to the top surface of the underlying pixel electrode and the bottom surface of the overlying transparent electrode.

As can be clearly seen in FIG. 3A, because of the distorting effect of a nearby spacer, when no electric field is applied to the liquid crystal cell the LC molecule alignment is non-uniform. That is, the LC molecules near the edge of the liquid crystal cell tend to align to the sides of the nearby spacers 134, producing a distortion in the LC molecule orientation in the cell. In the normally-black mode device, some light is reflected by the pixel electrodes near the areas where the LC molecule orientation is distorted, causing the black level of the display to be made less black. This produces a reduced contrast ratio in the display and also a visible pattern of artifacts which follows the arrangement of the spacers 134 in the reflective LCD device.

Accordingly, it would be desirable to provide a reflective liquid crystal display device having spacers with reduced visible artifacts and increased contrast ratio. Other and further objects and advantages will appear hereinafter.

### SUMMARY OF THE INVENTION

It is therefore an object of the invention to provide a reflective liquid crystal display (LCD) device having spacers with reduced visible artifacts and increased contrast ratio. In accordance with one aspect of the invention, a normally-white mode reflective LCD device comprises a silicon substrate, an insulating layer on the substrate, a plurality of pixel electrodes above the insulating layer separated by a plurality of inter-pixel gaps, and a plurality of spacers in the inter-pixel gaps, wherein the plurality of spacers are approximately equal in number to the plurality of pixel electrodes. Preferably, each spacer is located approximately equidistant from the corners of four of the pixel electrodes. Also, beneficially, the ratio of the width of the pixel electrodes to the width of the inter-pixel gaps is at least approximately 10:1.

### BRIEF DESCRIPTION OF THE DRAWINGS

FIG. 1 shows a simplified cross-sectional view of a portion of a prior-art reflective liquid crystal display (LCD) device;

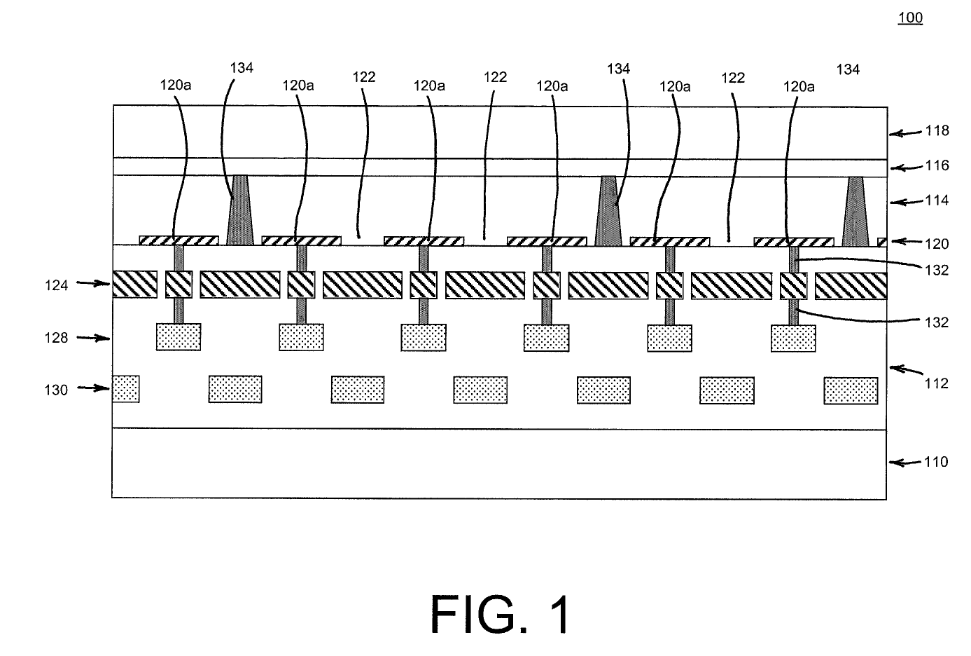

FIG. 2 shows a top plan view of a portion of the reflective LCD device shown in FIG. 1.

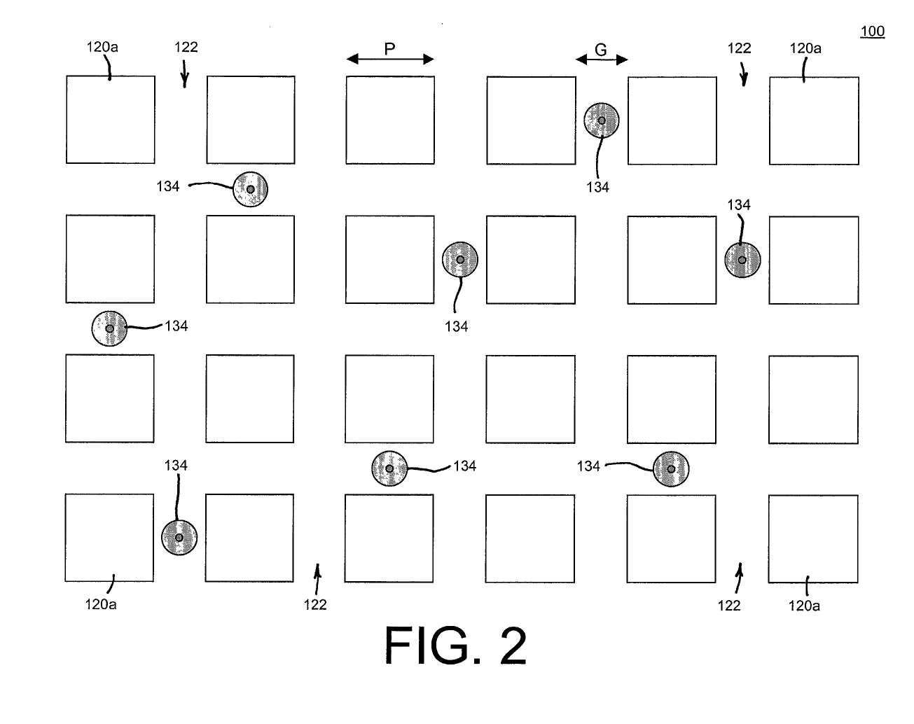

FIGS. 3A-D illustrate various orientations of the optical axes of the LC molecules in liquid crystal cells;

FIG. 4 shows a simplified cross-sectional view of a portion of one embodiment of a reflective LCD device having integrated spacers in accordance with one or more aspects of the invention; and

FIG. 5 shows a top plan view of a portion of the reflective LCD device shown in FIG. 4.

### DETAILED DESCRIPTION

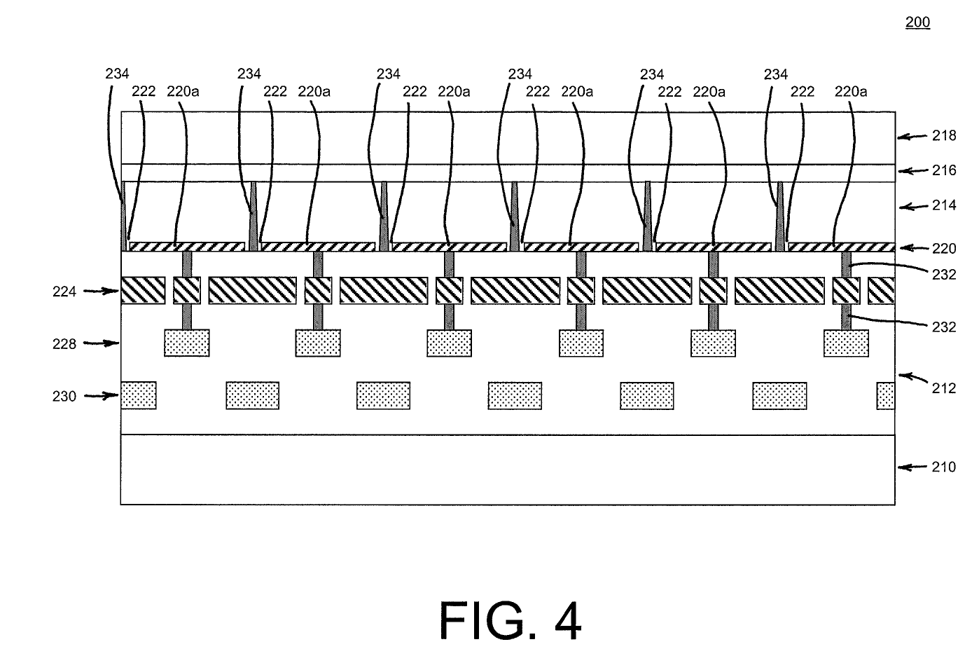

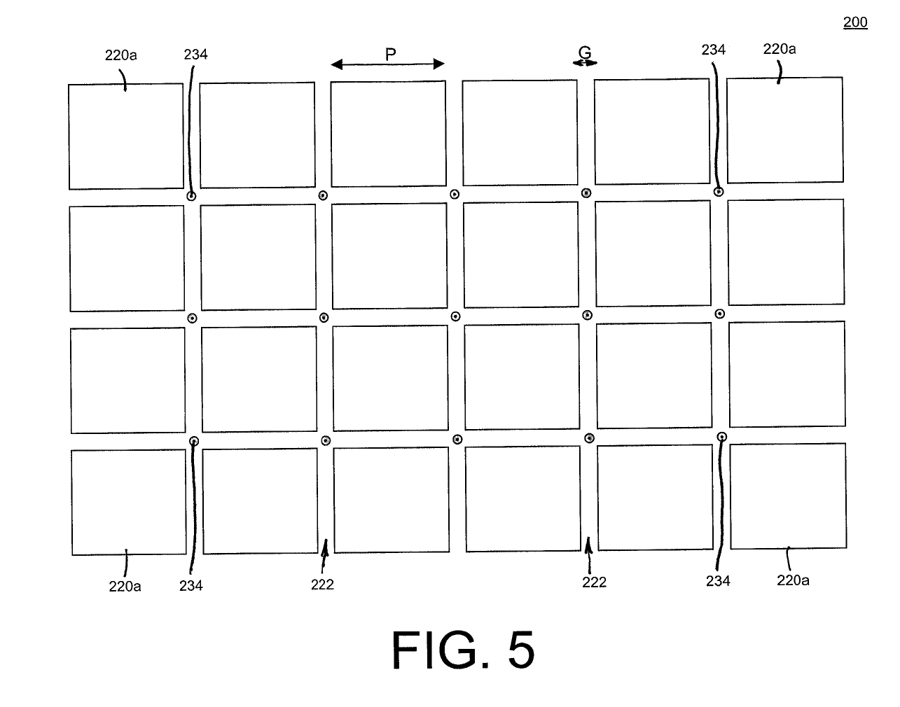

FIG. 4 shows a simplified cross-sectional view of a portion of a reflective LCD device 200 in accordance with one or more aspects of the invention, and FIG. 5 shows a top plan view of a portion of the prior art reflective LCD device 200. For clarity, those portions of the device relating to the present invention are illustrated.

The reflective LCD device 200 comprises, in relevant part, a silicon substrate 210 on which are successively provided an insulating layer 212, a liquid crystal layer 214, a transparent electrode 216, such as indium-tin-oxide (ITO), and a transparent (e.g., glass) layer 218. A first metal layer 220 is provided on the insulating layer 212 beneath the liquid crystal layer 214. The first metal layer 220 includes a plurality of individual reflective pixel electrodes 220a. Cell gap, or inter-pixel gap, regions 222 are located between the pixel electrodes 220a. Also, a light shield second metal layer 224 is provided between the first metal layer 220 and the substrate 210. Third and fourth metal layers 228 and 230 are provided between the second metal layer 224 and the substrate 210. Metal plugs 232 are provided for connecting various portions of the second, third, and fourth metal layers with each other.

A plurality of integrated spacers or pillars 234 are provided for supporting the glass layer 218 and providing a gap for the liquid crystal layer 214.

An explanation of various pertinent features of the preferred embodiment will now be described.

Beneficially, the reflective LCD device 200 operates as a “normally-white” mode device. That is, when no electric field is applied to a liquid crystal cell of the reflective LCD device 200, the cell reflects a maximum intensity of light to display a white pixel. On the other hand, when an electric field is applied to the normally-white mode liquid crystal cell, the cell displays a black pixel. In the normally-white mode device, any distortion or non-uniformity of the orientation of the LC molecules at the edge of a liquid crystal cell or pixel due to a nearby spacer 234 will have a minimized effect on the black level because of the dominating uniform electric field in the liquid crystal cell when it is in the black state. Meanwhile, any distortion or non-uniformity of the orientation of the LC molecules near the edge of the pixel when no electric field is applied produces a less noticeable effect, as the liquid crystal cell is in the white state and light is strongly reflected from the pixel electrode 200a. Therefore the normally-white mode reflective LCD device exhibits a greater contrast ratio.

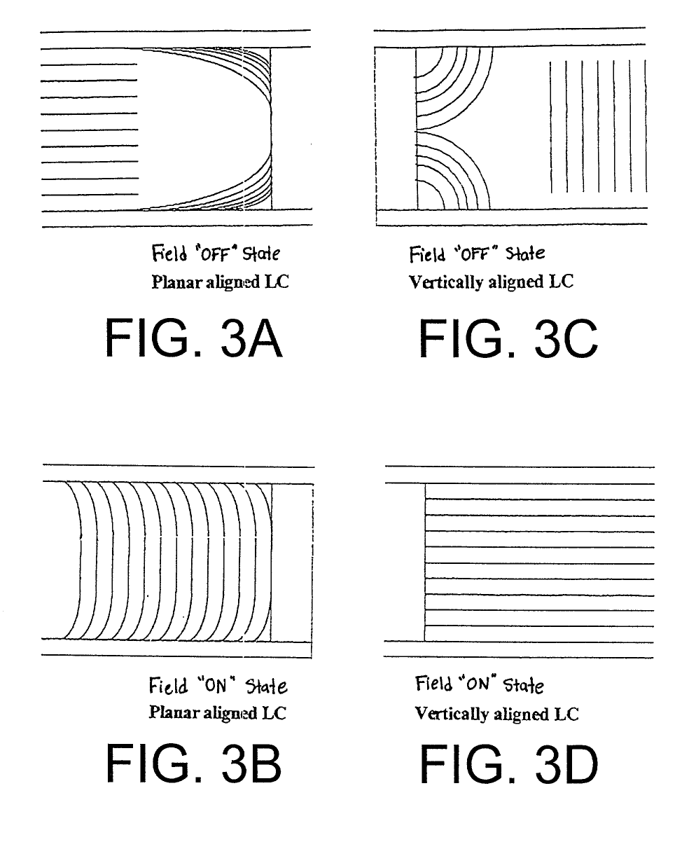

Preferably, the LC layer of the LCD device 200 is planar aligned such that, when no electric field is applied to the cell, the LC molecules are generally aligned in parallel with the top and bottom exposed surfaces of the cell (i.e., the top surface of the underlying pixel electrode 220a and the bottom surface of the overlying transparent electrode 226), as illustrated in FIG. 3A. Meanwhile, when the electric field is applied to the cell, the LC molecules are aligned substantially parallel to the electric field (i.e., substantially perpendicular to the top surface of the underlying pixel electrode and the bottom surface of the overlying transparent electrode), as illustrated in FIG. 3B.

Moreover, as can be seen in FIG. 5, in the reflective LCD device 200 the spacers 234 are beneficially placed uniformly in the cell gap regions 222, each of the spacers 234 being approximately equally spaced between corners of four pixel electrodes 220a. Beneficially, the reflective LCD device 200 has a high spacer density of approximately one spacer per pixel. Typically, a pixel size is chosen to be at the resolution limit of a viewer of the display. Therefore, by utilizing a high spacer density of approximately one spacer as one per pixel, any artifacts produced by spacers occur at distances generally too closely spaced together to be resolved by a viewer. Accordingly, visibility of any artifacts produced by the spacers is reduced.

By placing the spacers 234 approximately equidistant from four corners of four pixel electrodes 200a in the LCD device 200, the spacers are placed as far as possible from each of the four individual liquid crystal cells to thereby reduce any distortion or non-uniformity of the orientation of the LC molecules at the corner of a cell caused by the spacer 234.

Beneficially, in the LCD device 200 a width “P” of the pixel electrode 220a is 10 μm, and a width “G” of a cell gap 222 is 1 μm. That is, the ratio of the pixel width to the cell gap width is preferably approximately 10:1 or greater. With a reduced cell gap width, the fractional portion of any liquid crystal cell affected by distortion or non-uniformity of LC molecule orientation due to a nearby spacer 234 is reduced.

Preferably, the integrated spacers 234 may be formed by uniformly applying a coating (e.g., Si₃N₄; SiO₂) over the insulating layer 212 to a desired height, and etching the coated material to produce the integrated spacers 234. The height of the spacers 234 is selected to provide the desired gap for the liquid crystal layer 214. In one embodiment, the spacers 234 may have a height of 1-2 μm.

Meanwhile, the spacers 234 are also fabricated to be narrow in width to increase the distance from the spacer 234 to each of the four individual liquid crystal cells, and to reduce any distortion or non-uniformity of the orientation of the LC molecules at the corner of a cell due to the spacer 234. In one embodiment, the spacers 234 may have a width of 0.6 μm. That is, for a cell gap or inter-pixel gap of 1 μm, a ratio of a spacer width to a width of a cell gap or inter-pixel gap in which the spacer is located is preferably approximately 0.6 or less. However, as the spacer is preferably located at an intersection of inter-pixel gaps extending in substantially perpendicular directions, as shown in FIG. 5, the ratio of the spacer width to the width of the inter-pixel gap in which the spacer is located may be as large as approximately 1.0 or less.

Accordingly, in the preferred embodiment, a normally-white mode reflective LCD device uses a combination of narrow inter-pixel gaps and very narrow spacers placed in the inter-pixel gaps at a high spacer density (say, one spacer per pixel) to increase the contrast ratio of the device and reduce visible artifacts.

While the present invention has been particularly shown and described with reference to the preferred embodiments thereof, it will be understood by those skilled in the art that various changes in detail may be made without departing from the scope of the invention as defined by the claims.

What is claimed is:

1. A normally-white mode reflective liquid crystal display (LCD) device, comprising:
a silicon substrate;
an insulating layer on the substrate;
a plurality of pixel electrodes above the insulating layer separated by a plurality of inter-pixel gaps; and
a plurality of spacers in the inter-pixel gaps, each spacer located approximately equidistant from four of the pixel electrodes,
wherein the plurality of spacers are approximately equal in number to the plurality of pixel electrodes, and
wherein a ratio of a width of a pixel electrode to a width of an adjacent inter-pixel gap is at least approximately 10:1.

2. The LCD device of claim 1, wherein each spacer is located approximately equidistant from a corner of each of the four pixel electrodes.

3. The LCD device of claim 1, wherein a ratio of a width of a spacer to a width of an inter-pixel gap in which the spacer is located is less than approximately 1:1.

4. The LCD device of claim 1, further comprising a plurality of liquid crystal cells each corresponding to one of the pixel electrodes, and wherein when an electric field is applied to a one of the pixel electrodes, liquid crystal molecules of the corresponding liquid crystal cell align themselves substantially perpendicularly to a top surface of the pixel electrode.

5. A normally-white mode reflective liquid crystal display (LCD) device, comprising:
a silicon substrate;
an insulating layer on the substrate;
a plurality of pixel electrodes above the insulating layer separated by a plurality of inter-pixel gaps; and
a plurality of spacers in the inter-pixel gaps,
wherein the plurality of spacers are approximately equal in number to the plurality of pixel electrodes.

6. The LCD device of claim 5, wherein each of the plurality of spacers is at a location in the inter-pixel gap corresponding to a corner of at least one of the pixel electrodes.

7. The LCD device of claim 5, wherein a ratio of a width of a pixel electrode to a width of an adjacent inter-pixel gap is at least approximately 10:1.

8. The LCD device of claim 5, wherein a ratio of a width of a spacer to a width of an inter-pixel gap in which the spacer is located is less than approximately 1:1.

9. The LCD device of claim 5, further comprising:
a liquid crystal layer on the pixel electrodes, comprising a plurality of liquid crystal molecules; and
a transparent electrode on the liquid crystal layer and the spacers.

10. The LCD device of claim 9, wherein the liquid crystal molecules align themselves substantially perpendicularly to a top surface of the pixel electrode when an electric field is applied to the pixel electrode.

11. A reflective liquid crystal display (LCD) device, comprising:
a silicon substrate;
an insulating layer on the substrate;
a plurality of pixel electrodes above the insulating layer separated by a plurality of inter-pixel gaps;
a liquid crystal layer on the pixel electrodes; and
a plurality of integrated spacers in the inter-pixel gaps,
wherein the plurality of spacers are approximately equal in number to the plurality of pixel electrodes.

12. The LCD device of claim 11 wherein the liquid crystal layer is arranged to operate in a normally-white mode to display a white color when no electric field is applied to the pixel electrodes.

13. The LCD device of claim 11, wherein each of the plurality of integrated spacers is at a location in the inter-pixel gap corresponding to a corner of at least one of the pixel electrodes.

14. The LCD device of claim 11, wherein a ratio of a width of a pixel electrode to a width of an adjacent inter-pixel gap is at least approximately 10:1.

15. A method of producing a normally-white mode liquid crystal display (LCD) device, comprising:
forming an insulating layer on a substrate;
forming a plurality of pixel electrodes above the insulating layer separated by a plurality of inter-pixel gaps; and
forming a plurality of spacers in the inter-pixel gaps, each said spacer being formed approximately equidistant from four of the pixel electrodes,
wherein the plurality of spacers are approximately equal in number to the plurality of pixel electrodes.

16. The method of claim 15, wherein a ratio of a width of a pixel electrode to a width of an adjacent inter-pixel gap is at least approximately 10:1.

17. The method of claim 15, further comprising:
forming a liquid crystal layer on the pixel electrodes, comprising a plurality of liquid crystal molecules; and
forming a transparent electrode on the liquid crystal layer and the spacers.

18. The method of claim 17, wherein the liquid crystal layer is formed to be planar aligned wherein when no electric field is applied to one of the pixel electrodes, liquid crystal molecules of the corresponding liquid crystal cell align themselves substantially in parallel to a top surface of the pixel electrode.

19. The method of claim 15, wherein a ratio of a width of a spacer to a width of an inter-pixel gap in which the spacer is located is less than approximately 1:1.
